(19) United States
(12) Patent Application Publication
(10) Pub. No.: US 2002/0131186 A1
(43) Pub. Date: Sep. 19, 2002

(54) Storage disk having surface profile variations patterned to reduce slider airbearing modulation

(75) Inventors: Hal Hjalmar Ottesen, Rochester, MN (US); Gordon James Smith, Rochester, MN (US)

Correspondence Address: James R. Nock, IBM Corporation, Dept. 917, 3605 Highway 52 North, Rochester, MN, 55901-7829, US

(73) Assignee: International Business Machines Corporation, Armonk, NY (US)

(21) Appl. No.: 09/772,670

(22) Filed: Jan. 29, 2001

(51) Int. Cl. G11B 5/02

(52) U.S. Cl. 360/25

(57) ABSTRACT

A storage disk having surface profile variations patterned to reduce airbearing modulation of a head slider body in a storage device. The storage disk has a plurality of tracks each having an inner diameter (ID) edge and an outer diameter (OD) edge. The ID edge and the OD edge each comprise surface profile variations having a temporal frequency at a rated storage disk velocity. The surface profile variations of the ID edge of a first one of the tracks have at least one differing pattern parameter relative to the surface profile variations of the OD edge of the first track and/or the ID edge of a second one of the tracks adjacent to the first track, to thereby reduce slider airbearing modulation caused by the surface profile variations as the storage disk rotates. The differing pattern parameter may be circumferential skew, depth, period and/or shape. Preferably, the surface profile variations of the ID edge of each of the tracks have the differing pattern parameter relative to the surface profile variations of the OD edge of that same track and/or the ID edge of another one of the tracks adjacent that same track, to thereby form a substantially non-synchronous pattern, e.g., random, pseudo-random, or monotonic, as observed by the airbearing slider as the storage disk rotates. A controller coupled to an actuator may be used to control transducer position based on a response, e.g., thermal response, of the transducer to the surface profile variations of the ID and/or OD edges.

### CROSS-REFERENCE TO RELATED APPLICATION

This patent application is related to IBM Docket No.: ROC9-2000-0208-US 1, filed 5 concurrently, entitled “Method and Apparatus for Positioning a Transducer Using a Phase Difference in Surface Profile Variations on a Storage Medium”, which is assigned to the assignee of the instant application.

### FIELD OF THE INVENTION

The present invention relates in general to data storage systems. In particular, the present invention relates to a storage disk having surface profile variations patterned to reduce airbearing modulation of recording head slider bodies.

### BACKGROUND

A typical magnetic data storage system includes a magnetic medium for storing data in magnetic form and a transducer used to write and read magnetic data respectively to and from the medium. A disk storage device, for example, includes one or more data storage disks coaxially mounted on a hub of a spindle motor. The spindle motor rotates the disks at speeds typically on the order of several thousand revolutions-per-minute. Digital information, representing various types of data, is typically written to and read from the data storage disks by one or more transducers, or read/write heads, which are mounted to an actuator assembly and passed over the surface of the rapidly rotating disks.

The actuator assembly typically includes a coil assembly and a plurality of outwardly extending arms having flexible suspensions with one or more transducers and slider bodies being mounted on the suspensions. The suspensions are interleaved within the stack of rotating disks, typically using an arm assembly (E-block) mounted to the actuator assembly. The coil assembly, typically a voice coil motor (VCM), is also mounted to the actuator assembly diametrically opposite the actuator arms. The coil assembly generally interacts with a permanent magnet structure, and is responsive to a transducer positioning controller.

In a typical digital magnetic data storage system, digital data is stored in the form of magnetic transitions on a series of concentric, spaced tracks comprising the surface of the magnetizable rigid data storage disks. The tracks are generally divided into a plurality of sectors, with each sector comprising a number of information fields. One of the information fields is typically designated for storing data, while other fields contain track and sector identification and synchronization information, for example. Data is transferred to, and retrieved from, specified track and sector locations by the transducers which follow a given track and may move from track to track, typically under servo control of a position controller.

The head slider body is typically designed as an aerodynamic lifting body that lifts the transducer off the surface of the disk as the rate of spindle motor rotation increases, and causes the transducer to hover above the disk on an airbearing cushion produced by high speed disk rotation. The separation distance between the transducer and the disk, typically 0.1 microns or less, is commonly referred to as head-to-disk spacing.

Writing data to a data storage disk generally involves passing a current through the write element of the transducer to produce magnetic lines of flux which magnetize a specific location of the disk surface. Reading data from a specified disk location is typically accomplished by a read element of the transducer sensing the magnetic field or flux lines emanating from the magnetized locations of the disk. As the read element passes over the rotating disk surface, the interaction between the read element and the magnetized locations on the disk surface results in the production of electrical signals in the read element. The electrical signals correspond to transitions in the magnetic field emanating from the magnetized locations on the disk.

Conventional data storage systems generally employ a closed-loop servo control system to move the actuator arms to position the read/write transducers to specified storage locations on the data storage disk. During normal data storage system operation, a servo transducer, generally mounted proximate the read/write transducers, or, alternatively, incorporated as the read element of the transducer, is typically employed to read servo information for the purpose of following a specified track (track following) and seeking specified track and data sector locations on the disk (track seeking).

A servo writing procedure is typically implemented to initially prerecord servo pattern information on the surface of one or more of the data storage disks. A servo writer assembly is typically used by manufacturers of data storage systems to facilitate the transfer of servo pattern data to one or more data storage disks during the manufacturing process.

In one known servo technique, embedded servo pattern information is written to the disk along segments extending in a direction generally outward from the center of the disk. The embedded servo pattern is thus formed between the data storing sectors of each track. It is noted that a servo sector typically contains a pattern of data, often termed a servo burst pattern, used to maintain alignment of the read/write transducers over the centerline of a track when reading and writing data to specified data sectors on the track. The servo information may also include sector and track identification codes which are used to identify the position of the transducer. The embedded servo technique offers significantly higher track densities than dedicated servo, in which servo information is taken from one dedicated disk surface, since the embedded servo information is more closely co-located with the targeted data information.

In a further effort to increase disk capacity, a proposed servo information format was developed, termed pre-embossed rigid magnetic (PERM) disk technology. As described and illustrated in Tanaka et al., Characterization of Magnetizing Process for Pre-Embossed Servo Pattern of Plastic Hard Disks, I.E.E.E. Transactions on Magnetics 4209 (Vol. 30, No. 2,November 1994), a PERM disk contains embossed servo information in a number of servo zones spaced radially about the disk. Each servo zone contains pre-embossed recesses and raised portions to form a fine pattern, clock mark, and address code. The fine pattern and address code are used to generate servo information signals. To generate these servo information signals, the magnetization direction of the raised portions and the recesses must be opposite. The magnetization process involves first magnetizing the entire disk in one direction using a high-field magnet. Then, a conventional write head is used to magnetize the raised areas in the opposite direction.

While use of a PERM disk may increase disk capacity, such an approach suffers from a number of shortcomings. Servo information is provided on a PERM servo disk in a two-step magnetization process, as described above. This significantly increases the amount of time required to write servo information to the disk. Moreover, during the second step of the process, servo information is not yet available on the disk. Thus, an external positioning system must be employed, thereby increasing the cost of the servo writing process. Additional concerns associated with PERM disk technology include durability.

Finally, the PERM disk, like other embedded servo techniques, still stores servo information in disk space that could otherwise be used for data storage. As a result, PERM disk technology, although still at the research level, has not been widely accepted by industry.

Pre-embossed rigid thermal (PERT) disk technology uses the thermal response of a magnetoresistive (MR) head induced by servo information on a storage medium in order to position the MR head. As described in U.S. Pat. No. 5,739,972, issued Apr. 14, 1998 to Gordon J. Smith et al. and assigned to the assignee of the instant application, a PERT disk includes servo information provided to induce a thermal response in the MR head. The servo information is typically provided in the form of pre-embossed surface profile variations on the disk. A controller controls the relative position between the MR head and the embossed disk track using the thermal response induced in the MR head.

Typically in PERT disk technology, a read signal from an MR head is filtered to separate thermal and magnetic components. As disclosed in U.S. Pat. No. 6,088,176, issued Jul. 11, 2000 to Gordon J. Smith et al. and assigned to the assignee of the instant application, the thermal and magnetic components of a MR read signal are separated using a finite impulse response (FIR) filter. The thermal component is the thermal response of the MR head to the surface profile variations on the PERT disk. For the purpose of track following, for example, the surface profile variations may include serrated inner diameter (ID) and outer diameter (OD) track edges, which are radially aligned. For each track, the ID edge serration has a different serration frequency than the OD edge serration. By examining the frequency content of the thermal component of the read signal, the off-track direction and magnitude of the MR head can be determined and an appropriate control signal provided to the actuator to position the MR head over the centerline of a track.

This multiple-frequency track serration arrangement provides improved track following without sacrificing data capacity of a disk. Unlike embedded servo techniques, this arrangement does not store servo information in disk space that could otherwise be used for data storage. However, the multiple-frequency track serration arrangement presents a number of disadvantages. Because the serrations are radially aligned, and thus appear to the head slider body as repetitive and synchronous disk height variations, the serrations can cause airbearing modulation for head slider bodies. A similar two-frequency pit arrangement is disclosed in U.S. Pat. No. 5,251,082, issued Oct. 5, 1993 to Elliott et al. and suffers from analogous disadvantages. The Elliott et al. patent discloses the use of its two frequency pit arrangement to induce a magnetic read signal, i.e., no thermal component is utilized.

There exists in the data storage system manufacturing industry a need for an enhanced servo information format which reduces airbearing modulation of head slider bodies. The present invention addresses this and other needs.

### SUMMARY OF THE INVENTION

In accordance with one aspect of the present invention, there is provided a storage disk for use in a storage device. The storage disk has a plurality of tracks each having an inner diameter (ID) edge and an outer diameter (OD) edge. The ID edge and the OD edge each comprise surface profile variations having a temporal frequency at a rated storage disk velocity. The surface profile variations of the ID edge of a first one of the tracks are circumferentially skewed relative to the surface profile variations of the OD edge of the first track and/or the ID edge of a second one of the tracks adjacent to the first track, to thereby reduce slider airbearing modulation caused by the surface profile variations as the storage disk rotates. Preferably, the surface profile variations of the ID edge of each of the tracks are circumferentially skewed relative to the surface profile variations of the OD edge of that same track and/or the ID edge of another one of the tracks adjacent that same track, to thereby form a substantially non-synchronous spacial pattern, e.g., random, pseudo-random, or monotonic, as observed by the airbearing slider as the storage disk rotates. This eliminates any excitation of the airbearing at any of its natural frequencies.

In accordance with a second aspect of the present invention, there is provided a storage device having storage disk and a transducer mounted on a slider. An actuator is provided to position the transducer relative to the storage disk. A motor rotates the storage disk relative to the transducer at a rated storage disk velocity. The slider floats on an airbearing over the storage disk as the storage disk rotates. The storage disk has a plurality of tracks each having an inner diameter (ID) edge and an outer diameter (OD) edge. The ID edge and the OD edge each comprise surface profile variations having a temporal frequency at the rated storage disk velocity. The surface profile variations of the ID edge of a first one of the tracks are circumferentially skewed relative to the surface profile variations of the OD edge of the first track and/or the ID edge of a second one of the tracks adjacent to the first track, to thereby reduce slider airbearing modulation caused by the surface profile variations as the storage disk rotates. A controller coupled to the actuator is provided to control the position of the transducer relative to the storage disk based on a response, e.g., thermal response, of the transducer to the surface profile variations of at least one of the ID and OD edges. Preferably, the surface profile variations of the ID edge of each of the tracks are circumferentially skewed relative to the surface profile variations of the OD edge of that same track and/or the ID edge of another one of the tracks adjacent that same track, to thereby form a substantially non-synchronous pattern, e.g., random, pseudo-random, or monotonic, as observed by the airbearing slider as the storage disk rotates. This eliminates any excitation of the airbearing at any of its natural frequencies.

In accordance with a third aspect of the present invention, there is provided a storage disk for use in a storage device. The storage disk has a plurality of tracks each having an inner diameter (ID) edge and an outer diameter (OD) edge. The ID edge and the OD edge each comprise surface profile variations having a temporal frequency at a rated storage disk velocity. The surface profile variations of the ID edge of a first one of the tracks have at least one differing pattern parameter relative to the surface profile variations of the OD edge of the first track and/or the ID edge of a second one of the tracks adjacent to the first track, to thereby reduce slider airbearing modulation caused by the surface profile variations as the storage disk rotates. The differing pattern parameter(s) may be circumferential skew, depth, period and/or shape. Preferably, the surface profile variations of the ID edge of each of the tracks have the differing pattern parameter(s) relative to the surface profile variations of the OD edge of that same track and/or the ID edge of another one of the tracks adjacent that same track, to thereby form a substantially non-synchronous pattern, e.g., random, pseudo-random, or monotonic, as observed by the airbearing slider as the storage disk rotates. This eliminates any excitation of the airbearing at any of its natural frequencies.

### BRIEF DESCRIPTION OF THE DRAWINGS

FIG. 1 is a top view of a data storage system with its upper housing cover removed.

FIG. 2 is a side plan view of a data storage system comprising a plurality of data storage disks.

FIG. 3 is an exaggerated side view showing a data storage disk exhibiting various surface defects and features, and a thermal and magnetic response of an MR head to such defects and features.

FIG. 4 is a cross-sectional view of a magnetoresistive element of a transducer in an on-track orientation over the centerline of a track of a disk.

FIG. 5 is a top view of a disk having track markers, servo markers, a calibration zone and an index marker.

FIG. 6 is an enlarged top view of a portion of a disk having track markers that separate adjacent tracks according to an embodiment of the present invention where the track markers are circumferentially skewed to reduce slider airbearing modulation.

FIG. 6A is a more enlarged view of an edge-to-edge skew arrangement.

FIG. 6B is an enlarged top view of a track-to-track skew arrangement.

FIG. 7 is an enlarged perspectives view of a portion of a disk having two adjacent tracks separated by a track marker.

FIG. 8 is an illustration of thermal frequency magnitude responses of an MR head as a function of the MR head position over a track of a disk.

FIG. 9 is a block diagram of a servo system of a data storage system that utilizes track markers for track following.

### DETAILED DESCRIPTION OF THE PREFERRED EMBODIMENTS

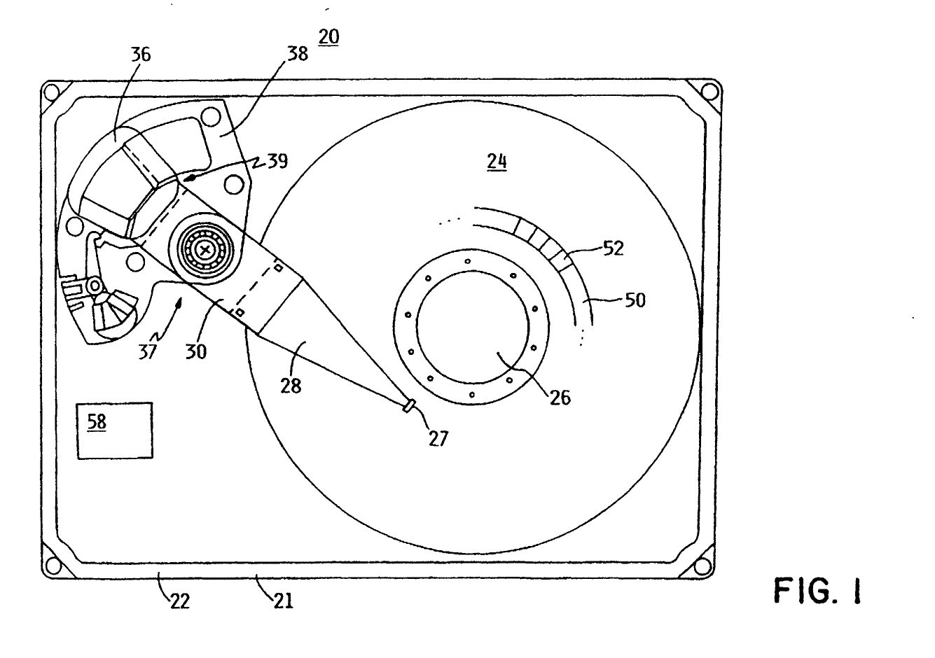

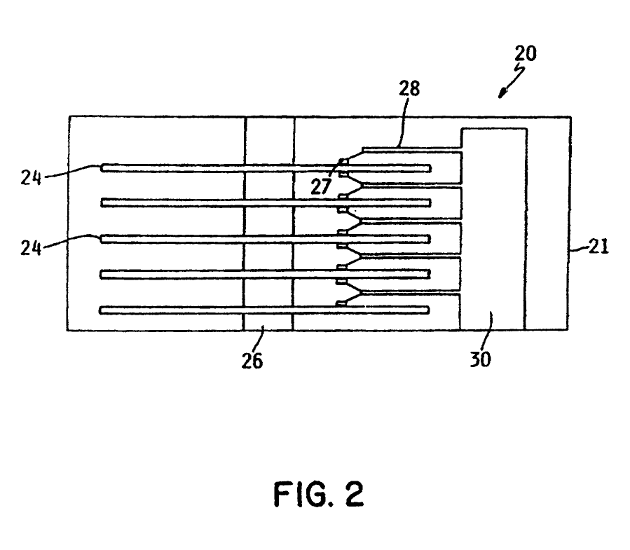

Referring now to the drawings, and more particularly to FIG. 1, there is shown a magnetic data storage system 20 with its cover (not shown) removed from the base 22 of the housing 21. As best seen in FIG. 2, the magnetic data storage system 20 typically includes one or more rigid data storage disks 24 which rotate about a spindle motor 26. The rigid data storage disks 24 are typically constructed with a metal, ceramic, glass, or plastic substrate upon which a recording layer is formed. In one typical construction, a magnetizable recording layer is formed on an aluminum or ceramic substrate. In another typical construction, an aluminum optical recording layer is formed on a plastic substrate. Referring back to FIG. 1, an actuator assembly 37 typically includes a plurality of interleaved actuator arms 30, with each arm having one or more suspensions 28 and transducers 27. The transducers 27 typically include components both for reading and writing information to and from the data storage disks 24. Each transducer 27 may be, for example, a magnetoresistive (MR) head having a write element and a MR read element. Alternatively, each transducer may be an inductive head having a combined read/write element or separate read and write elements, or an optical head having separate or combined read and write elements. The actuator assembly 37 includes a coil assembly 36 which cooperates with a permanent magnet structure 38 to operate as an actuator voice coil motor (VCM) 39 responsive to control signals produced by controller 58. The controller 58 preferably includes control circuitry that coordinates the transfer of data to and from the data storage disks 24, and cooperates with the VCM 39 to move the actuator arms 30 and suspensions 28, to position transducers 27 to prescribed track 50 and sector 52 locations when reading and writing data from and to the disks 24.

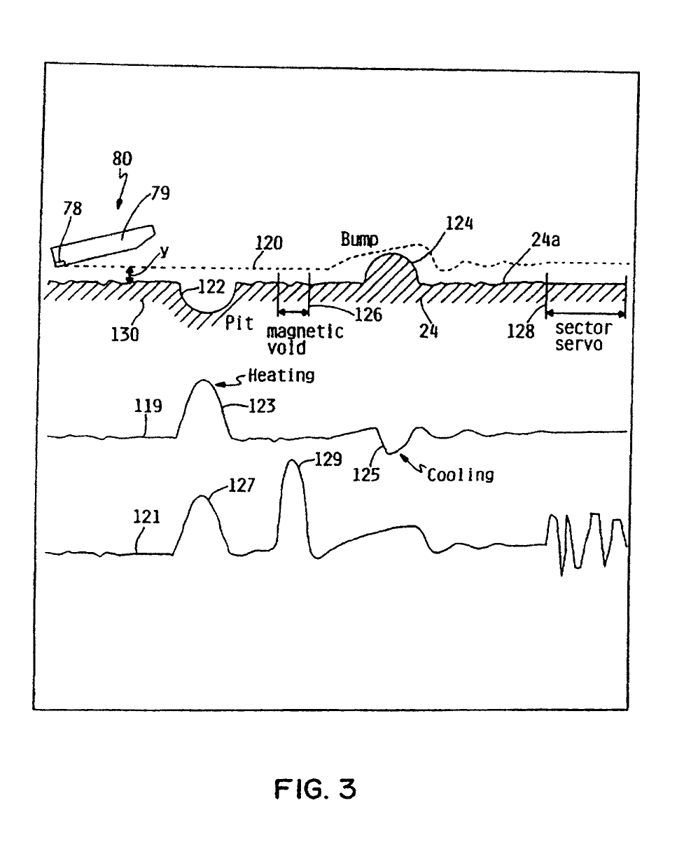

In FIG. 3, there is illustrated an exaggerated side plan view of an MR head slider 79 flying in proximity with the surface 24a of a magnetic data storage disk 24. The disk surface 24a has a generally varying topography at the microscopic level, and often includes various surface defects, such as a pit 122, a bump 124, or a surface portion 126 void of magnetic material. It is known that the thermal response of an MR head 80 changes as a function of the spacing, denoted by the parameter (y), between an MR element 78 of the MR head 80 and the disk surface 24a. See, for example, U.S. Pat. No. 5,739,972, issued Apr. 14, 1998 to Gordon J. Smith et al. and assigned to the assignee of the instant application.

The present invention may optionally use such a thermal response. Alternatively, the present invention may use a magnetic response or an optical response, or a combination thereof, such as a combination of a thermal response and a magnetic response. In any event, the present invention is not limited to the use of a thermal response. For example, a magnetic response may be used within the scope of the invention instead of, or in combination with, a thermal response.

Head-to-disk spacing changes result in concomitant changes in heat transfer between the MR element 78 and disk 24. This heat transfer results in an alteration in the temperature of the MR element 78. Temperature changes to the MR element 78 result in corresponding changes in the electrical resistance of the MR element 78 and, therefore, the output voltage of the MR element 78.

As the instantaneous head-to-disk spacing (y) increases, there results a corresponding increase in the air space insulation between the MR head 80 and the disk surface 24a, thereby causing an increase in the temperature of the MR element 78. This temperature increase in the MR element 78 results in a corresponding increase in the MR element 78 resistance due to the positive temperature coefficient of the MR element material typically used to fabricate the MR element 78. Permalloy, for example, is a preferred material used to fabricate the MR element 78 and demonstrates a temperature coefficient of +3×10⁻³/° C. An MR head 80 passing over a bump 124 on the disk surface 24a, by way of example, results in increased heat transfer occurring between the MR element 78 and the disk surface 24a, thereby causing cooling of the MR element 78. Such cooling of the MR element 78 causes a decrease in the MR element 78 resistance which, in turn, results in a corresponding decrease in the voltage VTH across the MR element 78 at a constant bias current.

It can be seen by referring to the pit 122 depicted on the disk surface 24a that the thermal voltage signal V_{TH} 119 across the MR element 78 increases in amplitude as a function of increasing head-to-disk separation distance (y). In can further be seen by referring to the bump 124 depicted on the disk surface 24a that the thermal voltage signal V_{TH} 119 decreases in amplitude as a function of decreasing head-to-disk separation distance. The thermal signal component of the readback signal, therefore, is in fact an information signal that can be used to detect the presence and relative magnitude of topographical variations in the surface of a magnetic data storage disk 24.

Also shown in FIG. 3 is a magnetic spacing signal 121 which has been conditioned to correspond to variations in the disk surface 24a. For example, the negative logarithm of a magnetic signal obtained by passing the signal through a logarithmic device produces a magnetic spacing signal that is linearly related to the head-to-disk spacing. It can be seen that the magnetic spacing signal 121 incorrectly indicates the presence of some surface features, such as magnetic voids 126, as variations in the topography of the disk surface 24a. It can further be seen that the magnetic spacing signal 121 can provide an inferior indication of other surface features, such as bumps, when compared to disk surface imaging information provided by use of the thermal signal 119. Nevertheless, it may be desirable to use the magnetic response of a transducer to variations in the disk surface in the present invention in lieu of the thermal response or in combination with the thermal response.

As is well known in the art, the thermal component of an MR element readback signal may be extracted using conventional techniques to obtain information regarding the surface characteristics of the rotating disk 24. To provide a background, a brief discussion of a conventional technique that is well known in the art for extracting the thermal component is discussed below. Additional information regarding such conventional techniques may be found in, for example, U.S. Pat. No. 5,739,972, issued Apr. 14, 1998 to Gordon J. Smith et al. and assigned to the assignee of the instant application. Of course, other techniques of extracting the thermal component may be used within the scope of the invention. That is, the present invention is neither limited to the particular conventional technique for extracting a thermal component discussed below nor the details thereof.

Servo information is encoded in a surface profile of the disk 24 and is read using a transducer having an MR element, e.g., an MR head 80. Because the servo information is provided in the profile of the disk and can be read concurrently with magnetically stored data, an additional 15%-20% of the disk is made available to store data (i.e., the portion of the disk used to provide the traditional embedded magnetic servo information).

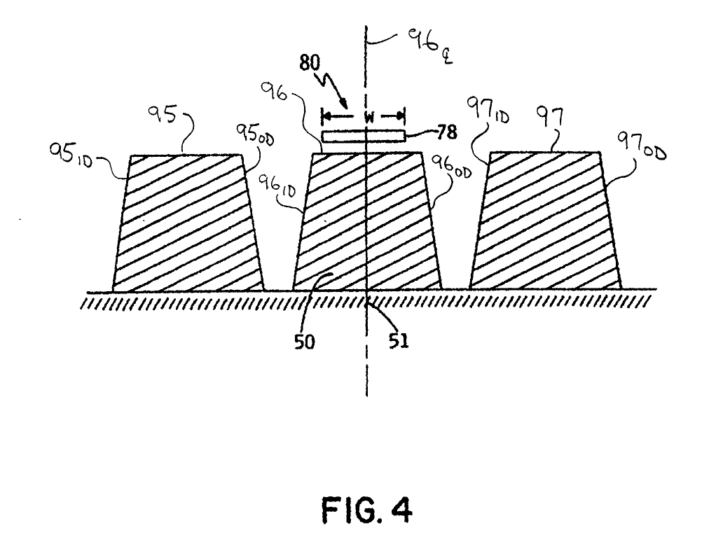

Turning now to FIG. 4, there is shown a cross-section illustration of an MR element 78 of an MR head 80 oriented over the centerline 51 of a data track 50. The MR head 80 may be a type used in conventional data storage systems, thus promoting the employment of the present invention in conventional storage systems. As the MR element 78 passes over the track 50 of the surface 24a of rotating disk 24, magnetic transitions developed on the surface 24a of disk 24 result in the production of a readback signal induced in the MR head 80. By way of example and not limitation, the readback signal is preferably a voltage signal.

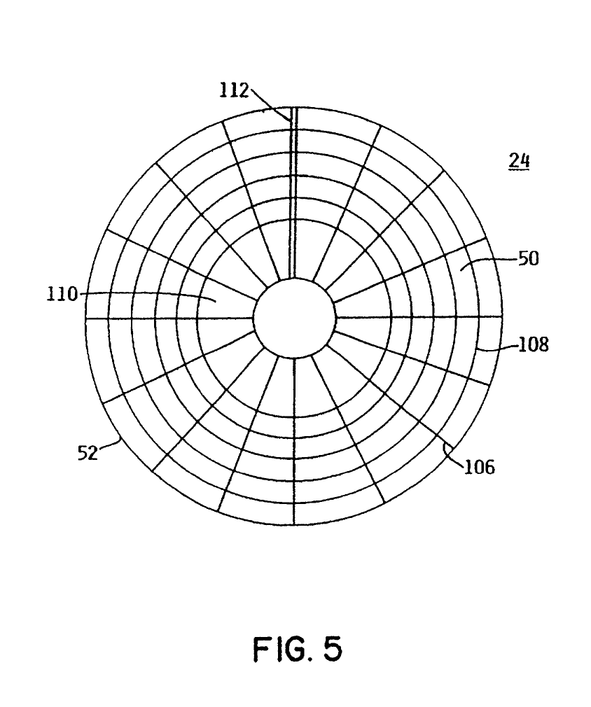

In FIG. 5, there is illustrated an exemplary disk 24 having pre-embossed track markers 108 for providing servo information on the disk 24 in the form of surface profile variations, e.g., head-to-disk spacing. As discussed in detail below, the surface profile variations that make up the track markers 108 are generally non-aligned radially to reduce airbearing modulation caused by the surface profile variations as the storage disk 24 rotates. Preferably, the surface profile variations that make up the track markers 108 are arranged to form a substantially non-synchronous pattern, e.g, random, pseudo-random, or monotonic, as observed by the slider 79 as the storage disk rotates.

The pre-embossed track markers 108 may be formed using various techniques well known in the art, such as mask/photo lithographic, injection molding, stamping, laser-ablation, and sputtering techniques. The disk 24 is provided with concentric data tracks 50 used to store data. Alternatively, a non-concentric data track configuration, such as a spiral data track, may be used to store data. Each data track 50 may be partitioned into a series of sectors 52 that may be identified by sector markers 106 in the form of conventional embedded magnetic servo information, or alternatively in the form of surface profile variations. Adjacent data tracks 50 are separated by track markers 108. The track markers 108 are formed as variations in the disk 24 which can be identified using either the thermal component or the magnetic component of the MR head readback signal.

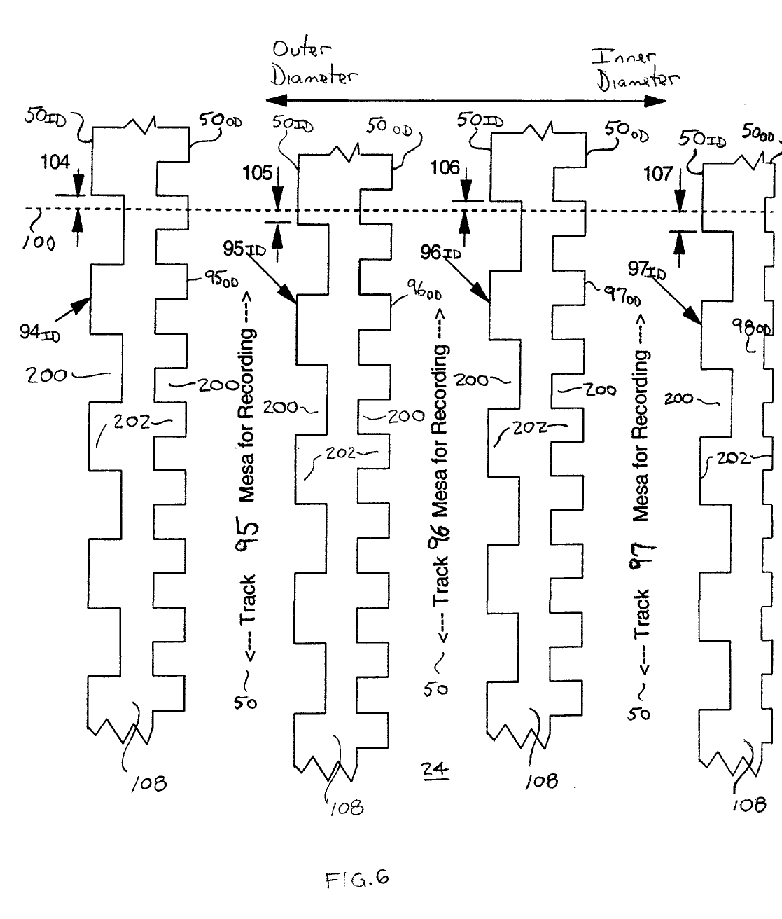

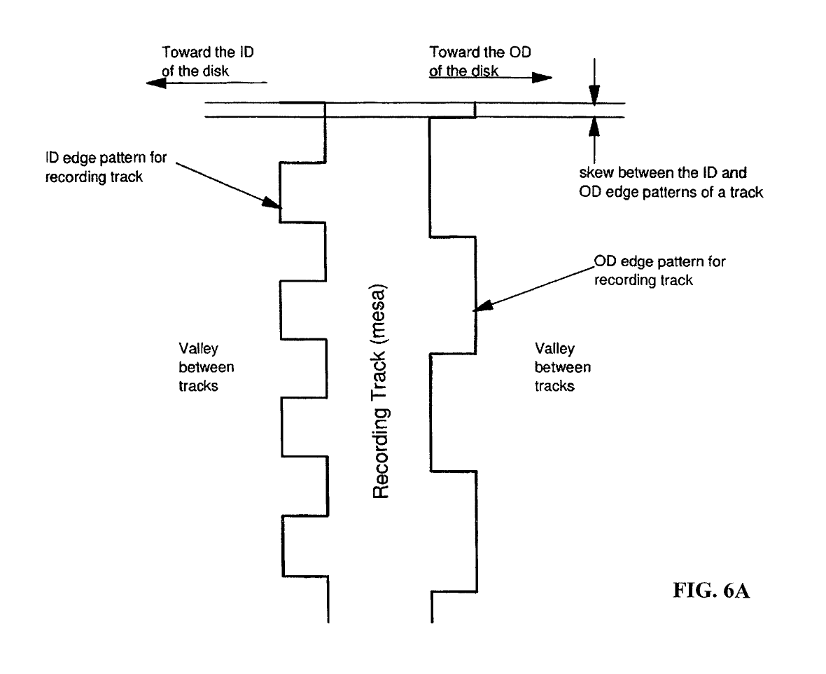

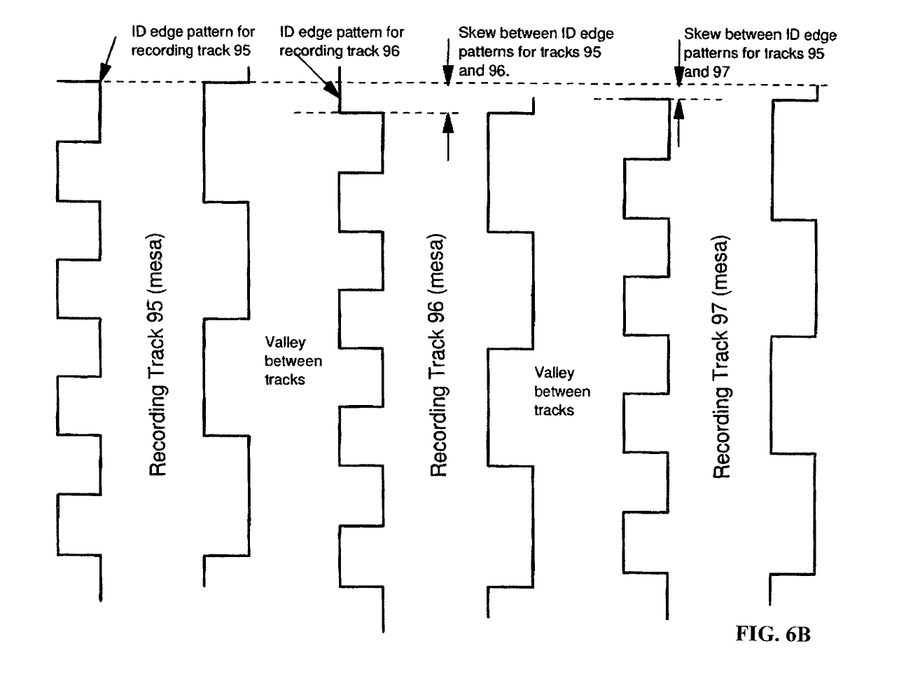

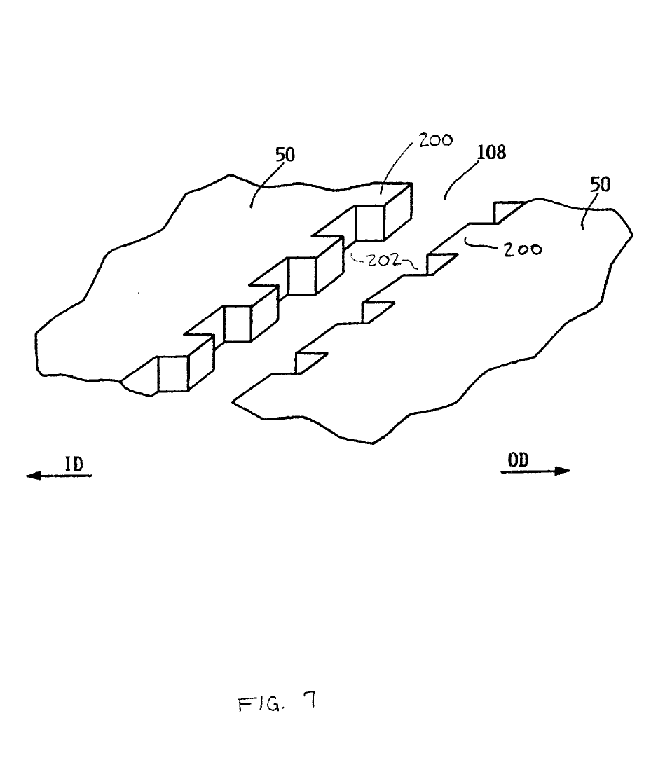

As shown in FIGS. 6 and 7, the track markers 108 may be circumferential patterns of mesas 200 and valleys 202 providing head-to-disk spacing variations between adjacent data tracks 50. For the sake of simplicity, each of the track markers 108 is shown along a straight line in FIGS. 6 and 7, though each is actually curved circumferentially about disk 24. As discussed in detail below, the track markers 108 are used to provide track-following servo information. The mesas 200 are preferably the same height as the data tracks 50, while the valleys 202 are preferably formed as circumferential grooves in the surface 24a of the disk 24. As is conventional, the sector markers 106 may include Gray code patterns to give track, head, and sector location information. As is also conventional, the disk 24 may be provided with a calibration zone 110 and an index marker 112, which may be formed by a closely spaced pair of sector markers 106.

As shown in FIGS. 6 and 7, the pattern of mesas 200 and valleys 202 for each track marker 108 may be formed in the surface 24a of the disk 24 as a serrated groove between adjacent data tracks 50. The data tracks 50 of disk 24 are provided with serrated edges 50_{ID} and 50_{OD} corresponding to the inner diameter (ID) and outer diameter (OD) edges of the track. For each track, the ID edge 50_{ID} serration has a different serration frequency than the OD edge 50_{OD} serration in order to provide radial direction servo information. The serrations may have the shape of a square-wave or a sinusoidal-wave. The serrations may have frequencies f₁ and f₂ which differ by a factor of two, for example, though it should be appreciated that the serrations may have a multitude of different frequencies provided each track has edge 50_{ID} and 50_{ID} at different frequencies. In addition, as discussed in detail below, the mesas 200 and the valleys 202 are generally non-aligned radially from track-to-track and/or edge-to-edge on the same track to reduce airbearing modulation caused by the mesas 200 and the valleys 202 as the storage disk 24 rotates. Preferably, the mesas 200 and the valleys 202 are so-arranged over a number of tracks to form a substantially non-synchronous pattern, e.g, random, pseudo-random, or monotonic, as observed by the slider 79 as the storage disk 24 rotates.

As shown in FIG. 6, each ID edge 50_{ID} has a serration frequency f₁, while each OD edge 50_{OD} has a serration frequency f₂ that is higher (or lower) than serration frequency f₁. Alternatively, the serrated edges 50_{ID} and 50_{OD} of the data tracks 50 may alternate in serration frequency. For example, some data tracks 50, referred to as odd tracks may have an ID edge 50_{ID} at serration frequency f₁ and an OD edge 50_{OD} at serration frequency f₂. While even data tracks 50_{ID}, would have OD edges 50_{OD} at a frequency f₁ and ID edge 50, at serration frequency f₂. By alternating the serration frequencies of adjacent data tracks 50, the serration edges of adjacent tracks 50 correspond as shown in FIG. 7. This makes the track markers 108, which separate adjacent tracks 50, easier to detect, and the disks 24 easier to manufacture.

In another alternative, the pattern of mesas 200 and valleys 202 may be formed on the surface 24a of the disk 24 as a serrated elevated ridge between adjacent tracks. The serrated elevated ridge may be formed by sputtering, for example. In yet another alternative, the valleys 202 may be non-contiguous pits formed in the surface 24a of the disk 24, while the mesas 200 may be the same height as the data tracks 50. In still another alternative, the mesas 200 may be non-contiguous elevated portions formed on the surface 24a of the disk 24, while the valleys 202 are the same height as the data tracks 50. However, in a typical environment, pits or grooves are preferred because they permit operation of the storage system 20 with minimal spacing between the MR heads and the data tracks.

An important aspect of the present invention is that the surface profile variations, e.g., the mesas and valleys formed by serrated grooves, serrated elevated ridges, pits, elevated portions and the like, are generally non-aligned radially. That is, the surface profile variations of the ID edge of a first one of the tracks are circumferentially skewed relative to the surface profile variations of the OD edge of the first track (e.g., skewed from edge-to-edge on the same track) and/or the surface profile variations of the ID edge of a second one of the tracks adjacent to the first track (e.g., skewed from track-to-track). This arrangement reduces airbearing modulation caused by the surface profile variations as the storage disk rotates. Preferably, the surface profile variations are so-arranged over a number of tracks to form a substantially non-synchronous pattern of roughness structure as observed by the slider as the slider hovers over those tracks. More preferably, the non-synchronous pattern is random, pseudo-random, or monotonic.

Thus, the surface profile variations of the present invention are deliberately not phase-aligned in either a radial or circumferential sense so that to the slider airbearing, which is typically of a scale 100-200 times larger than the track pitch, the surface profile variations appear as non-synchronous disk roughness. Excitation at the airbearing natural frequencies can be reduced or avoided during normal operation of the data storage system by this arrangement of the surface profile variations. The phase-aligned surface profile variations of the prior art arrangements can cause airbearing modulation at an airbearing natural frequency that can result in errors while reading and writing or worse yet, a head crash. It is these repetitive and synchronous disk height variations that can cause airbearing modulation. The present invention solves this problem by skewing the surface profile variations, e.g., the serrated edge patterns are skewed so that they are out non-aligned radially. In this case the slider airbearing sees a non-synchronous, e.g., random, pseudo-random or monotonic, disk height variation as the disk rotates rather than a synchronous one. This reduces or avoids exciting natural airbearing modulation modes that can be detrimental to reliable operation of a data storage system.

Referring now to FIG. 6, track edges 94_{ID}, 95_{ID}, 96_{ID} and 97_{ID}, each of which corresponds to an ID track edge 50_{ID}, respectively have the offsets 104, 105, 106 and 107 relative to a reference radial denoted as line 100. Likewise, track edges 95_{OD}, 96_{OD}, 97_{OD} and 98_{OD}, each of which corresponds to an OD track edge 50_{OD}, respectively have offsets 104, 105, 106 and 107 relative to the reference radial 100. That is, the track edges are skewed edge-to-edge on the same track. In other words, the surface profile variations of the ID edge of a first one of the tracks are circumferentially skewed relative to the surface profile variations of the OD edge of the first track (e.g., skewed from edge-to-edge on the same track). FIG. 6A shows a more enlarged view of such an edge-to-edge skew arrangement. Preferably, the offsets are non-synchronous, e.g., random, pseudo-random, or monotonic, over the typical width of a slider airbearing which is typically about 100-200 tracks. Accordingly, the disk roughness appears non-synchronous to the airbearing and does not produce net periodic disturbances as in the prior art.

Alternatively, or in addition, the track edges may be skewed track-to-track. For example, track edges 94_{ID} and 95_{OD} would not each have the same offset 104 as described in the previous example with respect to FIG. 6. In other words, the surface profile variations of the ID edge of a first one of the tracks are circumferentially skewed relative to the surface profile variations of the OD edge of a second one of the tracks adjacent to the first track (i.e., skewed from track-to-track). Such a track-to-track skew arrangement is shown in FIG. 6B.

In another alternative, or in addition, the pattern depth may be varied from track-to-track and/or edge-to-edge in a non-synchronous manner to suppress airbearing excitation. For example, the depth of the serrated groves that form the valleys 202 in FIG. 6 may vary in a random, pseudo-random or monotonic manner track-to-track from the ID to the OD of the disk 24.

In yet another alternative, or in addition, the period of the pattern along each track edge may be varied in a prescribed manner so that the track-to-track and/or edge-to-edge variation over the width of the airbearing causes the pattern to appear asynchronous with respect to disk rotation.

In still another alternative, or in addition, the shape of the pattern may be varied in order to alter the pressure profile beneath the airbearing so that the excitation is not at some airbearing natural frequency. For example, instead of exclusively using serrated edges that are square-wave shaped, some may be rounded (e.g., sinusoidal-wave shaped) so that the pressure beneath the airbearing is not periodic at some airbearing natural frequency. In this example, the shape of the serrated edges would vary from track-to-track and/or edge-to-edge.

Although the surface profile variations are generally non-aligned radially as discussed above, the valleys 202 are preferably longer and spaced further apart in the circumferential direction (mesas 200 are also longer) as one moves radially outward. This arrangement may be desirable in a constant angular velocity system, for example, as the serration frequencies relative to the MR head 80 would be constant over the entire surface of the disk 24. In addition, the number of spacial serration cycles around a data track 50 may be a power of two such that the data storage system oscillator frequency can be divided to exactly yield each of the temporal serration frequencies f₁ and f₂.

Servo information may also be derived from other variations in disk characteristics which can be reflected in the thermal component of the readback signal. These other variations are likewise referred to herein as surface profile variations. For example, the surface profile variations of the track markers 108 could differ in thermal emissivity or other parameters which can be detected in the thermal component. Similar variations in disk characteristics can be used for the sector markers 106.

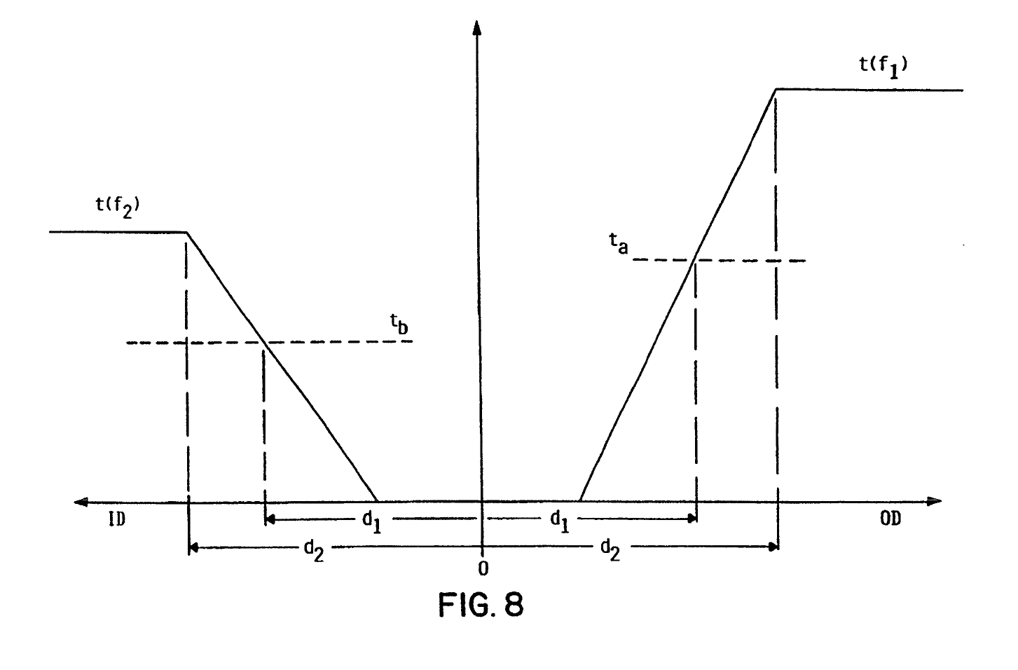

In FIG. 8, and referring also to FIG. 4, the frequency magnitude responses t(f₁) and t(f₂) of the thermal component of the MR head readback signal are illustrated as a function of the position of the MR element 78 of MR head 80 over an even data track 50, i.e., a data track 50 having a frequency f₂ at ID edge 50_{ID} and a frequency f₁ at OD edge 50_{OD}. When the MR element 78 is positioned over the center 51 of the data track 50, the thermal frequency magnitude responses t(f₁) and t(f₂) should be near zero. As the MR element 78 moves off toward the ID edge 50_{ID} of an even data track 50, the MR element 78 senses the edge serrations and thermal signal t(f₂) increases. Similarly, as the MR element 78 moves off toward the OD edge 50_{OD}, the MR element 78 senses the edge serrations and the thermal signal t(f₁) increases. It is noted that as the MR element 78 continues to move off-track, the thermal signals t(f₁) and t(f₂) plateau. As described more fully below, by examining the frequency content of the thermal component of the readback signal, the off-track direction and magnitude of the MR head 80 can be determined and an appropriate control signal provided to the actuator to position the MR head 80 over the centerline of a data track 50.

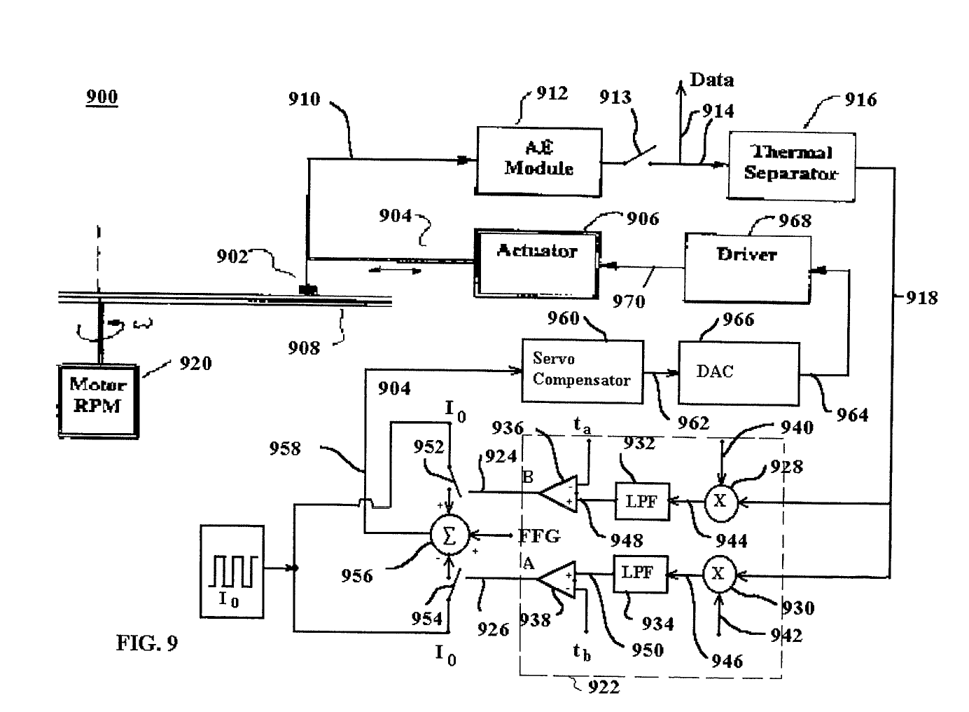

FIG. 9 shows a block diagram of an embodiment of a servo system 900 that utilizes track markers for track following. Although the servo system 900 shown in FIG. 9 is implemented as a digital system, an equivalent analog system may also be used.

An MR head 902 is attached to a suspension-arm 904, the motion of which is controlled by an actuator 906. The MR head 902 flies over one surface of a rotating disk 908. The disk 908 is spun by spindle motor 920. A readback signal 910 from the MR element of MR head 902 consists of both a magnetic component of high frequency content and a thermal component of low frequency content. The combined signal, i.e., the readback signal 910, is amplified in an arm electronics (AE) module 912. The amplified output from AE module is sampled by a sampler 913 at a sampling rate to produce a sampled readback signal 914. A typical sampling rate will be in excess of 100 megahertz (MHz). The sampled readback signal 914 is input to the recording channel (not shown) for normal processing and a thermal separator 916.

The thermal separator 916, which acts as a sophisticated lowpass filter extracts and provides a thermal signal 918. As is well known in the art, the thermal component of an MR element readback signal, such as the readback signal 910, may be extracted using conventional techniques to obtain information regarding the surface characteristics of a record medium, such as the rotating disk 908. Such conventional techniques may be found in, for example, U.S. Pat. No. 5,739,972, issued Apr. 14, 1998 to Gordon J. Smith et al. and assigned to the assignee of the instant application.

In one such conventional thermal signal extraction technique, the sampled readback signal is provided to a first filter, e.g., an inverse infinite impulse response (IIR) filter, to compensate for the high pass filter in the AE module. The output of the first filter is passed through a second filter, e.g., a moving average low-pass finite infinite response (FIR) filter, to recover the thermal component of the sampled readback signal. Typically the FIR filter averages over several samples to provide a moving average. The output of the second filter may optionally be passed through a third filter, e.g., an adaptive inverse filter, to restore the distorted thermal component during a write operation to that which would be present during read operation. That is, the write element-to-MR element heat transfer during the write operation distorts the thermal component of the readback signal. The dynamics of the write element-to-MR element heat transfer may be approximated by a first order lowpass filter transfer function. The distortion caused by the write element-to-MR element heat transfer may be substantially reduced by passing the signal leaving the second filter through the adaptive inverse filter having a transfer function inverse to that of the lowpass filter transfer function.

Use of the third filter, i.e., the adaptive inverse filter, is advantageous because it permits the MR element to thermally detect the track markers even while the write element is writing. This in turn permits a nearly real-time write-inhibit feature, wherein the write element is prevented from writing before the MR head is off-track by an amount sufficient to cause data loss. Such an off-track condition is detected almost instantaneously by continuous track following, which is made possible through the use of the track markers. This is advantageous over traditional embedded magnetic servo techniques, in which the off-track condition is detected significantly later, i.e., when the next servo sector is encountered.

Thus, in this conventional thermal signal extraction technique, the thermal separator includes an inverse IIR filter, a FIR filter and an optional adaptive inverse filter. Of course, other techniques of extracting the thermal component may be used within the scope of the invention. That is, the present invention is neither limited to this particular conventional technique for extracting a thermal component nor the details thereof.

In another alternative embodiment, a magnetic spacing signal may be used instead of the thermal signal 918. For example, the sampled readback signal 914 may be passed through a logarithmic device in lieu of thermal separator 916 to produce a magnetic spacing signal that is linearly related to the head-to-disk spacing. The remainder of the servo system 900 would remain unchanged in this alternative embodiment. In a further modification, it may be desirable to employ a both the magnetic response and the thermal response to the surface profile variations. For example, the thermal signal 918 obtained from the thermal separator 916 may be verified or calibrated using the magnetic spacing signal obtained from a logarithmic device (not shown).

The thermal signal 918 may be provided to a heterodyne demodulation circuit 922 to provide servo positioning control signals 924 and 926. Heterodyne demodulation circuit 922 determines whether thermal frequency magnitude components t(f₁) and t(f₂) of the readback signal 910 exceed their respective threshold values tₐ and t_{b}. The operation of the heterodyne demodulation circuit 922 is more fully explained below. Of course, other types of demodulation circuits may be used within the scope of the invention. That is, the present invention is neither limited to the heterodyne demodulation circuit discussed below nor the details thereof.

The heterodyne demodulation circuit 922 comprises first and second multipliers 928 and 930, first and second filters 932 and 934, and first and second comparators 936 and 938. The heterodyne demodulation circuit 922 extracts the thermal frequency magnitude response signals t(f₁) and t(f₂) from the thermal signal 918 and compares these to threshold values tₐ and t_{b} to generate servo positioning control signals 924 and 926. See, Table 1 below, where the values of servo positioning control signal 926 and 924 are shown in columns A and B, respectively.

TABLE 1

| A | B | Servo Action |
|---|---|---|
| 0 | 0 | None |
| 1 | 0 | Move Toward OD |
| 0 | 1 | Move Toward ID |
| 1 | 1 | Write Inhibit |
| | | Move Slightly to Find Track Identify |

In operation, the heterodyne demodulation circuit 922 receives thermal signal 918 and provides it to first and second multipliers 928 and 930. Multipliers 928 and 930 multiply the thermal signal 918, with two or more divided oscillator signals 940 and 942, respectively. The oscillator signals 940 and 942 may have waveforms and frequencies similar to the serration frequencies of the serrated edges generated when the disks 24 are rotated at rated speed. The multipliers 928 and 930 output signals 944 and 946 which have amplified frequency components at frequencies f₁ and f₂, respectively. Signals 944 and 946 are low-pass filtered by first and second filters 932 and 934, respectively, thereby rejecting the high frequency components of signals 944 and 946 to generate low frequency thermal magnitude response signals t(f₁) and t(f₂), designated 948 and 950, respectively. Thermal signals 948 and 950 are provided to comparators 936 and 938, respectively, for comparison with threshold values tₐ and t_{b}.

As best shown in FIG. 8, threshold values tₐ and t_{b} correspond to the threshold amplitudes of thermal signals t(f₁) and t(f₂) at which an MR head has moved off-track and should be repositioned. It is noted that threshold values tₐ and t_{b} are predetermined values for each MR head and are stored in a random access memory (RAM). The threshold values tₐ and t_{b} are determined in consideration of differences in thermal sensitivity along the width W of an MR element for different MR heads and may be different for different MR heads. Such a known threshold calibration procedure is disclosed in U.S. Pat. No. 5,739,972, issued Apr. 14, 1998 to Gordon J. Smith et al. and assigned to the assignee of the instant application

Comparator output signals 924 and 926 from comparators 936 and 938 may have a logical value of 0 or 1. When the MR head 902 is centered over a track, both outputs 924 and 926 may assume a logical value of 0, for example. If the thermal frequency response signal 948 exceeds threshold value tₐ, then comparator output signal 924 may assume a logical value of 1. Similarly, if the thermal frequency response signal 950 exceeds threshold value t_{b}, then comparator output signal 926 may assume a logical value of 1. If thermal frequency response signals 948 and 950 have frequency components at serration frequencies f₁ and f₂ above their respective thresholds, then both comparator outputs 924 and 926 will be a logical value of 1. This situation occurs when the MR head 902 is positioned over a valley. In this case, the MR 902 is moved slightly to find the track identity.

Comparator output signals 924 and 926 control switches 952 and 954, respectively, for coupling digital values +I₀ and −I₀ to an adder 956. When comparator output signal 924 assumes a logical value of 1, switch 952 is configured to close so that the value +I₀ is provided to the adder 956. Similarly, the value of −I₀ is provided to adder 956, when the comparator output signal 926 assumes a logical value of 1. The digital values +I₀ and −I₀ are provided as pulsed injection values to control position of the actuator. If both comparator output signals 924 and 926 assume a logical value of 0, both switches 952 and 954 remain open and no pulsed injection is provided to the adder 956. It is noted that, if both comparator outputs assume a logical value of 1, then the MR head 902 is positioned over a valley.

The adder 956 sums the pulsed injection value +I₀ or −I₀, if any, with a feed-forward generator (FFG) value and provides the summed signal 958 to the servo compensator 960. The FFG value represents MR axial offset and track runout as a function of disk 24 rotation and is provided to the adder 956 by a conventional feed-forward generator (not shown). The feed-forward generator stores the predetermined MR head 80 axial offset and track runout for each MR head 80 of a storage device in a random access memory (RAM). The track runout and head offset for each MR head 80 may be determined using a known calibration procedure. See, for example, the calibration procedure disclosed in U.S. Pat. No. 5,739,972, issued Apr. 14, 1998 to Gordon J. Smith et al. and assigned to the assignee of the instant application.

The servo compensator 960 processes signal 958, and taking into account the type of data track 50, e.g., odd or even, generates a servo positioning control signal 962. The servo compensator 960 may be omitted if different types of data tracks, e.g., odd and even, are not used. Typically, the functions of thermal separator 916, heterodyne demodulation circuit 922, feed-forward generator (FFG), adder 956 and servo compensator 960 are performed in a microprocessor. The servo positioning control signal 962 is converted to an analog signal 964 by a digital to analog converter (DAC) 966 and provided to an actuator driver 968, which in response provides an appropriate current 970 to the voice coil motor (VCM) 39 to move the actuator 906. In this manner, movement of the arm-suspension 904 is controlled so that the MR head 902 follows a given track 50, i.e., to position the MR head 902 over the centerline of the track 50.

The actuator driver 968 may serve as a bipolar pulse-width-modulator (PWM) to provide an actuator control signal 970 to the actuator 906 that positions MR head 902 over the center of a track, i.e., centered between adjacent track markers. Alternatively, the actuator driver 968 may serve as a simpler bang-bang driver, i.e., bipolar pulse amplitudes are fixed in amplitude and width but vary in polarity, for providing the actuator control signal 970 to the actuator 906 to position MR head 902 over the center of a track. In other words, the bang-bang driver provides small pulses that slowly move the actuator one way or another.

While this invention has been described with respect to the preferred and alternative embodiments, it will be understood by those skilled in the art that various changes in detail may be made therein without departing from the spirit, scope, and teaching of the invention. For example, the invention may be utilized in systems employing optical storage medium. Accordingly, the herein disclosed invention is to be limited only as specified in the following claims.

What is claimed is:

1. A storage disk for use in a storage device having a transducer provided on a slider and a motor for rotating the storage disk relative to the transducer at a rated storage disk velocity, the slider floating on an airbearing over the storage disk as the storage disk rotates, the storage disk comprising:
a plurality of tracks each having an inner diameter (ID) edge and an outer diameter (OD) edge, said ID edge and said OD edge each comprise surface profile variations having a frequency at the rated storage disk velocity, said surface profile variations of said ID edge of a first one of said tracks being circumferentially skewed relative to said surface profile variations of at least one of said OD edge of said first track and said ID edge of a second one of said tracks adjacent to said first track, to thereby reduce airbearing modulation caused by said surface profile variations as the storage disk rotates.

2. The storage disk as recited in claim 1, wherein said surface profile variations of said ID edge of each of said tracks being circumferentially skewed relative to said surface profile variations of at least one of said OD edge of that same track and said ID edge of another one of said tracks adjacent that same track, to thereby form a substantially non-synchronous pattern as observed by the slider as the storage disk rotates.

3. The storage disk as recited in claim 2, wherein said substantially non-synchronous pattern is random or pseudo-random.

4. The storage disk as recited in claim 2, wherein said substantially non-synchronous pattern is monotonic.

5. The storage disk as recited in claim 1, wherein the transducer is a magnetoresistive (MR) head, said frequency of said surface profile variations of said ID edge at the rated storage disk velocity being different than said frequency of said surface profile variations of said OD edge at the rated storage disk velocity, each falling within a frequency range associated with a thermal response of said MR head.

6. The storage disk as recited in claim 5, wherein said surface profile variations of said ID edge and said OD edge each comprise a repeating track marker pattern of mesas and valleys.

7. The storage disk as recited in claim 1, wherein said surface profile variations of said ID edge and said OD edge respectively comprise serrations having a first frequency and a second frequency, said first frequency being different than said second frequency.

8. The storage disk as recited in claim 7, wherein said first frequency is twice said second frequency.

9. A storage device, comprising:
a storage disk;
a transducer provided on a slider;
an actuator provided to move said transducer relative to said storage disk;
a motor provided to rotate said storage disk relative to said transducer at a rated storage disk velocity, said slider floating on an airbearing over said storage disk as said storage disk rotates;
said storage disk comprising a plurality of tracks each having an inner diameter (ID) edge and an outer diameter (OD) edge, said ID edge and said OD edge each comprise surface profile variations having a frequency at said rated storage disk velocity, said surface profile variations of said ID edge of a first one of said tracks being circumferentially skewed relative to said surface profile variations of at least one of said OD edge of said first track and said ID edge of a second one of said tracks adjacent to said first track, to thereby reduce airbearing modulation caused by said surface profile variations as said storage disk rotates;
a controller coupled to said actuator and provided to control movement of said transducer relative to said storage disk based on a response of said transducer to said surface profile variations of at least one of said ID and OD edges.

10. The storage device as recited in claim 9, wherein said surface profile variations of said ID edge of each of said tracks being circumferentially skewed relative to said surface profile variations of at least one of said OD edge of that same track and said ID edge of another one of said tracks adjacent that same track, to thereby form a substantially non-synchronous pattern as observed by said slider as said storage disk rotates.

11. The storage device as recited in claim 10, wherein said substantially non-synchronous pattern is random or pseudo-random.

12. The storage device as recited in claim 10, wherein said substantially non-synchronous pattern is monotonic.

13. The storage device as recited in claim 9, wherein said transducer is a magnetoresistive (MR) head, said frequency of said surface profile variations of said ID edge at said rated storage disk velocity being different than said frequency of said surface profile variations of said OD edge at said rated storage disk velocity, each falling within a frequency range associated with a thermal response of said MR head.

14. The storage device as recited in claim 13, wherein said surface profile variations of said ID edge and said OD edge each comprise a repeating track marker pattern of mesas and valleys.

15. A storage disk for use in a storage device having a transducer provided on a slider and a motor for rotating the storage disk relative to the transducer at a rated storage disk velocity, the slider floating on an airbearing over the storage disk as the storage disk rotates at the rated storage disk velocity, the storage disk comprising:
a plurality of tracks each having an inner diameter (ID) edge and an outer diameter (OD) edge, said ID edge and said OD edge each comprise surface profile variations having a frequency at the rated storage disk velocity, said surface profile variations of said ID edge of a first one of said tracks having at least one differing pattern parameter relative to said surface profile variations of at least one of said OD edge of said first track and said ID edge of a second one of said tracks adjacent to said first track, to thereby reduce airbearing modulation caused by said surface profile variations as the storage disk rotates, said differing pattern parameter being selected from a group including circumferential skew, depth, period and shape.

16. The storage disk as recited in claim 15, wherein said surface profile variations of said ID edge of each of said tracks having said differing pattern parameter relative to said surface profile variations of at least one of said OD edge of that same track and said ID edge of another one of said tracks adjacent that same track, to thereby form a substantially non-synchronous pattern as observed by the slider as the storage disk rotates.

17. The storage disk as recited in claim 16, wherein said substantially non-synchronous pattern is random or pseudo-random.

18. The storage disk as recited in claim 16, wherein said substantially non-synchronous pattern is monotonic.

19. The storage disk as recited in claim 15, wherein the transducer is a magnetoresistive (MR) head, said frequency of said surface profile variations of said ID edge at the rated storage disk velocity being different than said frequency of said surface profile variations of said OD edge at the rated storage disk velocity, each falling within a frequency range associated with a thermal response of said MR head.

20. The storage disk as recited in claim 19, wherein said surface profile variations of said ID edge and said OD edge each comprise a repeating track marker pattern of mesas and valleys.
